(19) United States
(12) Patent Application Publication
(10) Pub. No.: US 2026/0105677 A1
(43) Pub. Date: Apr. 16, 2026

(54) MAPPING TWO-DIMENSIONAL ("2D") SURFACES TO THREE-DIMENSIONAL ("3D") SURFACES BASED ON CORRESPONDING ANCHOR POINTS

(71) Applicant: Adobe Inc., San Jose, CA (US)

(72) Inventor: Jean-Francois El Hajjar, Clermont-Ferrand (FR)

(21) Appl. No.: 18/915,028

(22) Filed: Oct. 14, 2024

(51) Int. Cl. G06T 15/04; G06T 17/20

(52) U.S. Cl. CPC G06T 15/04; G06T 17/20; G06T 2210/12

(57) ABSTRACT

Techniques for mapping two-dimensional (“2D”) surfaces to three-dimensional (“3D”) surfaces based on corresponding anchor points are disclosed. In an example method, a computing system receives information about a 3D mesh and a 2D surface. The computing system receives a first selection of a set of 2D anchor points. The computing system, for each 2D anchor point, receives a second selection of a 3D anchor point mapped to the 2D anchor point. The computing system determines a first mapping of the 2D points to the 3D points, including selecting a first set of 3D points and, for each 3D point selected, computing, using an inverse operation, a first set of weights and computing, using a forward operation, a 2D point mapped to the 3D point. The computing system outputs a first image of the 2D surface mapped onto the 3D surface using the first mapping.

### TECHNICAL FIELD

This disclosure generally relates to 2D parameterization of a 3D surface, and, more specifically, to techniques for mapping 2D surfaces to 3D surfaces based on corresponding anchor points.

### BACKGROUND

Some 3D graphics processing operations can involve mapping of a bounded 2D surface, sometimes referred to as a texture or “decal,” to a 3D surface. Determination of such a mapping can be referred to generally as a parameterization of the 3D surface. The 3D surface may be, for example, a 3D mesh which is a collection of vertices, edges, and faces that define the shape of a 3D object in 3D space. Parameterization of the 3D surface may involve determining which points of the texture, in the coordinate system of the texture, map to points on the 3D mesh in the coordinate system of the 3D mesh. In this example, the parameterization is a mapping of 3D points to 2D points.

Various approaches have been developed for texture parameterization. For example, the decal can be automatically mapped onto the 3D mesh using a suitable mapping technique. Hower, existing approaches that implement such automatic mapping techniques may result in artifacts or distortions that render the parameterization unusable for certain applications that require realistic or accurate mappings such as high-resolution video editing or video games. Additionally, some existing approaches may be limited to serial processing of mapped points.

### SUMMARY

Some embodiments described herein relate to techniques for mapping 2D surfaces to 3D surfaces based on corresponding anchor points. In an example method, a computing system receives first information about a 3D surface characterized by a 3D mesh, the 3D mesh including a number of 3D points. The computing system receives second information about a 2D surface, the 2D surface including a number of 2D points. The computing system receives a first selection of a set of 2D anchor points from among the number of 2D points. The computing system, for each 2D anchor point of the set of 2D anchor points, receives a second selection of a 3D anchor point mapped to the 2D anchor point to generate a set of 3D anchor points. The computing system determines a first mapping of the number of 2D points to the number of 3D points using the set of 2D anchor points and the set of 3D anchor points. Determining the first mapping includes selecting a first set of 3D points and, for each 3D point of the first set of 3D points: computing, using an inverse operation, a first set of weights based on the 3D point and the set of 3D anchor points and computing, using a forward operation, a 2D point mapped to the 3D point based on the first set of weights and the set of 2D anchor points. The computing system outputs a first image of the 2D surface mapped onto the 3D surface using the first mapping.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a diagram of an example system implementing techniques for mapping 2D surfaces to 3D surfaces based on corresponding anchor points, according to some examples of the present disclosure.

FIG. 2 is a flow diagram of an example process for mapping 2D surfaces to 3D surfaces based on corresponding anchor points, according to some aspects of the present disclosure.

FIG. 3A is a flow diagram of an example process for determining a mapping of the 2D points to 3D points using the set anchor points as part of mapping 2D surfaces to 3D surfaces based on corresponding anchor points, according to some aspects of the present disclosure.

FIG. 3B shows example implementation of the 3D inverse operation, according to some examples of the present disclosure.

FIG. 3C shows example implementation of the 2D forward operation, according to some examples of the present disclosure.

FIG. 4 depicts a GUI that can be used with some examples of mapping 2D surfaces to 3D surfaces based on corresponding anchor points, according to some aspects of the present disclosure.

FIG. 5A shows a graphical depiction of the greedy vertex parallel selection policy, according to some examples of the present disclosure.

FIG. 5B shows a graphical depiction of a surface partitioning that may be used by some implementation s of the greedy patch parallel selection policy, according to some examples of the present disclosure.

FIG. 5C shows a graphical depiction of the greedy patch parallel selection policy, according to some examples of the present disclosure.

FIG. 6A shows an example implementation of the greedy vertex parallel selection policy, according to some examples of the present disclosure.

FIG. 6B shows an example implementation of the mapping step used in some example implementations of the greedy vertex parallel selection, according to some examples of the present disclosure.

FIGS. 7A-B shows an example implementation of the greedy patch parallel selection policy, according to some examples of the present disclosure.

FIG. 7C shows an example implementation of the mapping step used in some example implementations of the greedy patch parallel selection, according to some examples of the present disclosure.

FIG. 8 is a flow diagram of an example process for preprocessing the 3D points of a 3D mesh as part of mapping 2D surfaces to 3D surfaces based on corresponding anchor points, according to some aspects of the present disclosure.

FIG. 9A shows an example implementation of the farthest point sampling strategy and generation of the distance matrix, according to some examples of the present disclosure.

FIG. 9B shows an example implementation of a metric multidimensional scaling process, according to some examples of the present disclosure.

FIG. 9C shows an example implementation of a linear interpolation process, according to some examples of the present disclosure.

FIG. 9D shows an example implementation of a process for determining the embedded tangent bases, according to some examples of the present disclosure.

FIG. 10 depicts an example of a computer system used in some examples for mapping 2D surfaces to 3D surfaces based on corresponding anchor points, according to some aspects of the present disclosure.

### DETAILED DESCRIPTION

Parameterization of a 3D surface to a bounded 2D surface or texture, sometimes referred to as a “decal,” generally involves determining a mapping between a set of coordinates on the 2D surface (e.g., uv coordinates) and a set of 3D coordinates on the 3D surface (e.g., xyz coordinates on a 3D mesh). Applications of the parameterization operation can include texture mapping, decal placement, medical imaging, and others.

Various approaches have been developed for parameterization of the decal. Existing approaches suffer from deficiencies that can result in distortion, seams, discontinuities, misalignments, boundary artifacts, among other problems. For example, a naïve approach may involve a simple planar projection of the 2D surface onto the 3D mesh. Except for relatively flat 3D meshes, this approach typically results in undesirable distortions of the decal, as parts of the decal will either unnaturally stretch or compress. Consequently, various mathematical methods can be used to develop the parameterization.

For example, some existing approaches to mapping 2D surfaces to three-dimensional 3D surfaces may involve methods such as creating a disk from the 2D surface that is homeomorphic (e.g., topologically identical) to the 3D mesh and mapping the disk to the 3D mesh with an emphasis on distortion minimization. Another existing approach involves logarithmic maps in which a mapping is locally computed given a central position on the 2D surface and a tangent plane on the 3D mesh.

Such approaches are typically based on extrinsic properties of the 3D mesh in which the mapping is greedily computed starting from positional boundary conditions and updated through Dijkstra-like (e.g., iteratively optimized) steps. However, these approaches are prone to correctness and robustness issues. For instance, as the mapping computations proceed, the iterative distance from the initial or seed grows, resulting in an accumulating loss of precision, especially in the vicinity of geometrical high frequencies (e.g., locally rapid 3D variations).

Some existing approaches may involve solving for the parameterization globally (i.e., over the entire 3D mesh) instead of the smaller 3D mesh domain used in the logarithmic approach. Such an approach can allow for consistency through global distribution of the error term and may provide higher quality results in some cases. However, the global parameterization method may be prone to poor robustness on poorly tessellated surfaces (e.g., meshes with at least one triangle that has at least one extreme angle). The resulting errors may require correction through manual efforts. The global parameterization method may also result in poor computational performance on large-scale 3D meshes, since the solution is over the full domain regardless of the corresponding 2D surface domain, which is typically much smaller than the full domain of the 3D mesh. Such performance issues can be mitigated somewhat through the implementation of localized solvers for systems of linear equations, but not without substantial additional effort that is not practical for most applications.

Another shortcoming of the existing approaches, particularly ones that require specification of the decal center position and gradient of a desired parameterization, is a poor user experience for 3D graphics artists. Regardless of the sophistication of the mapping approach, artists may still desire to refine the automatically obtained parameterization during 2D surface application so that, for example, some 2D surface features can be “tightly pinned” to specific regions on the 3D mesh. The existing approaches cannot efficiently numerically enforce such constraints while computing a globally consistent parameterization. As a result, 3D graphic artists may turn to time-consuming manual application of 2D surfaces to 3D meshes to avoid these distortions and to exercise a high degree of local control of the mapping. In some cases, involving complex 2D surfaces and/or 3D meshes, manual application may not be practical at all.

This shortcoming of the existing approaches is further complicated because the existing approaches may not be able to attain sub-tessellation accuracy for the boundary conditions (e.g., the 2D surface boundaries) as well as the additional constraints (e.g., the pinned 2D surface features). Sub-tessellation accuracy may be required for some 2D surface assets with optimized tessellation. In such cases, limiting the attachment of selected points of the 2D surface assets to vertices may be too limiting.

These and other related challenges can be overcome using techniques for mapping 2D surfaces to 3D surfaces based on corresponding anchor points. For example, some embodiments of the present disclosure can enable a 3D graphic artist to pin of any number of 2D coordinates of a 2D surface to arbitrary 3D points on the 3D mesh and then generate the resulting parameterization in near-real-time, enabling interactive editing sessions for the artist.

An example method for mapping 2D surfaces to 3D surfaces based on corresponding anchor points is provided to introduce certain concepts using this example. Consider a 3D graphic artist who desires to align minute features of a 2D surface to particular geometric features of the 3D mesh. For instance, the 2D surface may be a 2D decal containing lifelike details of a human eye. The artist desires to align the boundaries of the eye decal to its corresponding set of contiguous edges in the 3D mesh.

In the example method, a computing system includes a mapping subsystem. For example, the mapping subsystem may be included in rendering software that includes components for texture mapping. The computing system receives information about a 3D surface characterized by a 3D mesh that includes a number of 3D points. The computing system also receives information about a 2D surface (e.g., a texture or decal) that includes a number of 2D points. In the present example, the decal is the face texture, including the eye detail, and the 3D mesh is a 3D mesh representation of a human face.

The computing system then receives a selection of a set of 2D anchor points from among the 2D points. For example, the artist can use an input device to select a number of 2D anchor points on the face texture on and around the eye. To obtain a realistic or accurate appearance after mapping, the artist may select numerous points (e.g., 10s or 100s of anchor points). Then, for each 2D anchor point of the set of 2D anchor points, the computing system receives a selection of a set of 3D anchor points including a 3D anchor point for each 2D anchor point selected.

These pairs of 2D and 3D anchor points are then used by the computing system to determine a mapping of the 2D points of the 2D surface to the 3D points of the 3D mesh based on the selected pairs of corresponding 2D and 3D anchor points. Then, for each 3D point of the 3D points, a set of weights is computed based on the 3D point and the set of 3D anchor points. The weights can then be used to compute the 2D point to be mapped to the 3D point using the set of weights and the set of 2D anchor points. The completed parameterization includes a mapping of each 3D point to a 2D point.

In practice, computation of the mapping over all 3D points sequentially is inefficient and does not take advantage of the parallelizability of the mapping problem. The generation of the mapping can parallelized by selecting a number of subsets of the set of 3D points using a particular selection algorithm. Various selection algorithms can be used. The selection algorithm can be chosen to optimize the efficiency of the parameterization in accordance with the particular use case, based on factors such as the complexity of the 3D surface, the level detail of the 2D surface, and so on. The mapping of each of the selected subsets can then proceed in parallel, optimizing the efficiency of the parameterization and enabling a near-real-time user experience. Efficiency can be further improved by restricting the mapping to the domain of the 2D surface. This leads to additional gains in computational efficiency by requiring significantly less computations per vertex parameterization as compared to a full, global parameterization with an unrestricted 2D domain.

The completed parameterization is then used by the computing system to output an image of the 2D surface mapped onto the 3D surface using the mapping thus developed. The 3D graphic artist can make adjustments to the 2D or 3D anchor points and the mapping can be efficiently recomputed in near-real-time. In this example, the eye decal is mapped on the face mesh with distortions and artifacts minimized, resulting in a realistic appearance for the rendered 3D surface.

The techniques disclosed herein for techniques for mapping 2D surfaces to 3D surfaces based on corresponding anchor points constitute improvements to the technical fields of 3D graphics processing and, in particular, techniques for parameterizing 2D surfaces. Importantly, these techniques can enable a higher degree of user control than was previously attainable using existing approaches. For example, the techniques can enable near-real-time interactivity that can allow an artist to quickly and efficiently fine-tune the mapping. Furthermore, as emphasized above, the techniques enable fast, parallelized development of a mapping using the “pinned” anchor point pairs, resulting in a realistic appearance that is comparatively free of distortions and artifacts. Because the techniques can be implemented efficiently, taking advantage of parallel processing where available, near-real-time interactive sessions can be enabled. Additionally, the particular selection algorithm can be selected to optimize the efficiency of the algorithm depending on the particular decal and/or 3D mesh. The techniques are flexible in this respect, and compatible with a variety of point selection algorithms, some examples of which will be described herein.

The techniques can also improve the functioning of computers. In particular, certain point selection algorithms and the use of parallelization can consume computational resources more fully and efficiently, resulting in an overall decrease in the consumption of computational resources. Likewise, some of the methods described herein may involve numerical approximations that produce the desired accuracy with fewer computations.

### Overview

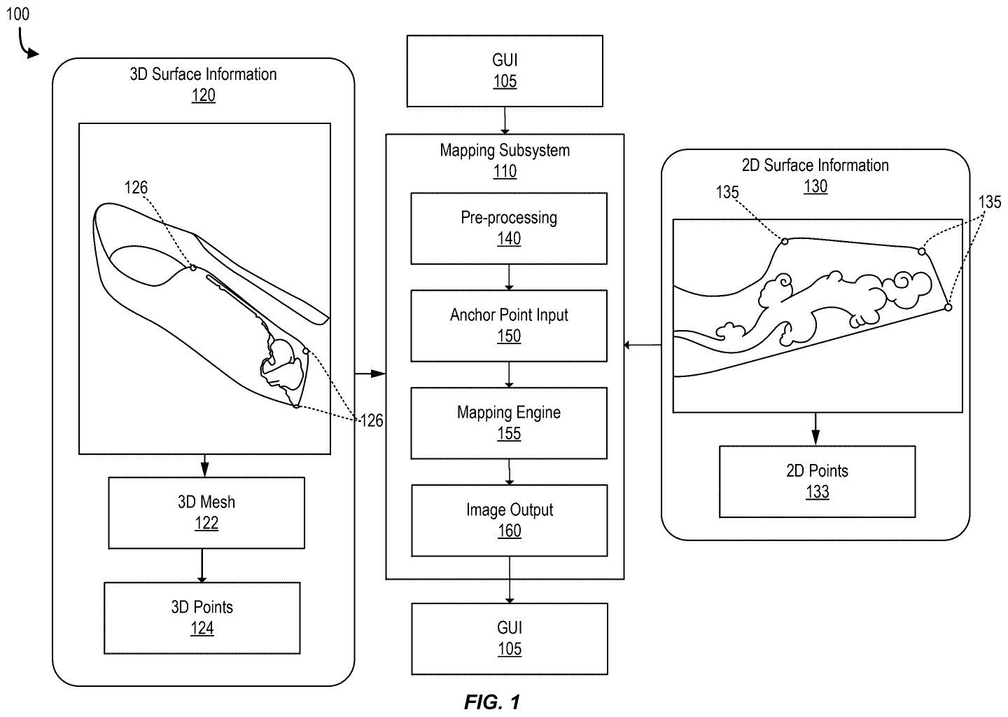

FIG. 1 is a diagram of an example system 100 implementing techniques for mapping 2D surfaces to 3D surfaces based on corresponding anchor points, according to some examples of the present disclosure. Example system 100 includes a mapping subsystem 110 that may include components for, for example, receiving information about a decal and 3D mesh, receiving anchor points, generating the mapping (also referred to as a 2D parameterization of 3D surface), and rendering images, among other functions.

The mapping subsystem 110 may include components implemented in hardware, software, or a combination of both. The components of mapping subsystem 110 can be part of a monolithic deployment to one server or may use a distributed architecture, in which components or sub-components are found on a number of servers. The servers hosting the components of mapping subsystem 110 may be physical hardware servers, virtual machines, cloud compute instances, or any combination thereof. The components of mapping subsystem 110 may be communicatively coupled using one or more networks including private networks (e.g., LANs), corporate WANs, virtual networks, the Internet, and so on.

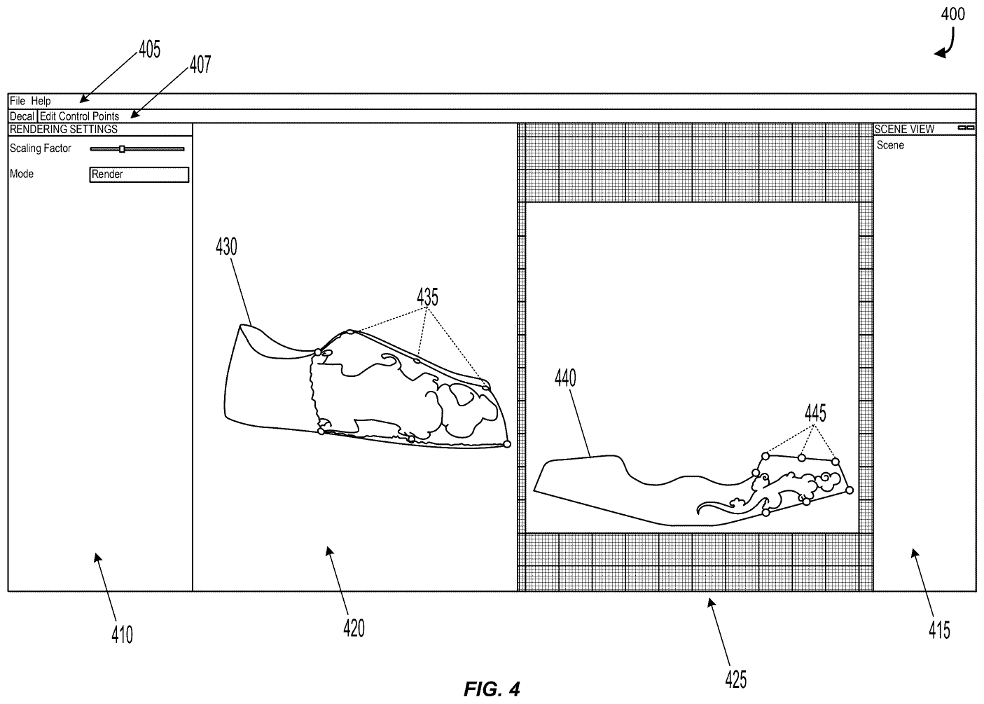

Graphical user interface (“GUI”) 105 is used to provide inputs to the mapping subsystem 110 using a suitable input device. Similarly, the GUI 105 can display outputs to the 3D graphic artist using the system 100 for mapping 2D surfaces to 3D surfaces based on corresponding anchor points. The GUI 105 may be provided as a web application, a native desktop application, a mobile application, or any other suitable implementation for receiving the inputs and displaying the outputs for mapping 2D surfaces to 3D surfaces based on corresponding anchor points. For instance, the GUI 105 may be used to select or modify decals, select or modify 3D meshes, select, edit, delete, or update anchor points, start or stop computation, and so forth. An example of a GUI 105 is shown below in FIG. 4.

The mapping subsystem 110 can receive information about a 3D surface 120 characterized by a 3D mesh 122 as may be indicated using the GUI 105. The 3D surface information 120 may include a 3D mesh 122, the 3D mesh 122 itself including a number of 3D points, the 3D mesh 122 including a number of 3D points 124. The 3D points 124 may define the 3D mesh 122 including a number of edges, vertices, and faces. In some examples, the faces of 3D mesh 122 can be triangles. In other examples of the 3D mesh 122, the faces may be other polygons.

The mapping subsystem 110 can likewise receive information about a 2D surface 130 by, for example, receiving a selection indicated using the GUI 105. The 2D surface 130 or decal, includes a number of 2D points 133. For example, the 2D surface 130 may be characterized by a 2D coordinate system, sometimes referred to as uv coordinates. The collection of uv coordinates can be the 2D points 133. The uv coordinates corresponding to the 2D points 133 are not necessarily mapped to the individual pixels of the 2D surface. For example, the uv coordinates may have sub-pixel resolution in which multiple uv coordinates refer to the same pixel. In this case, linear interpolation can be used to determine intermediate uv coordinates to avoid artifacts during rendering such as “blocky” effects that can occur due to under-sampling of the uv coordinates during the mapping. In some examples, cubic or other interpolation methods can be similarly employed. Conversely, the uv coordinates may have super-pixel resolution in which a single uv coordinate refers to the multiple pixels. In some examples, the uv coordinates may have a one-to-one correspondence with the pixels of the 2D surface 130.

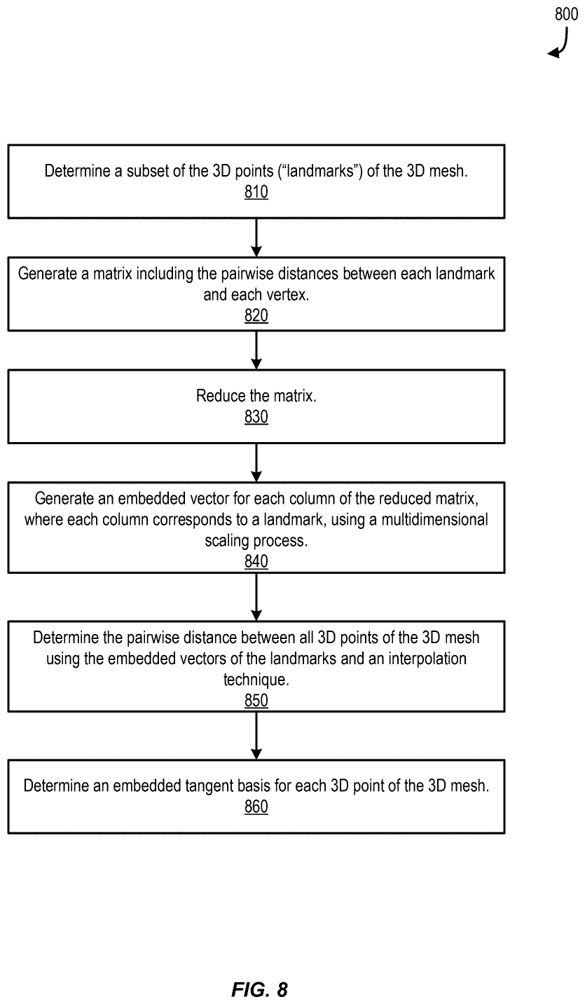

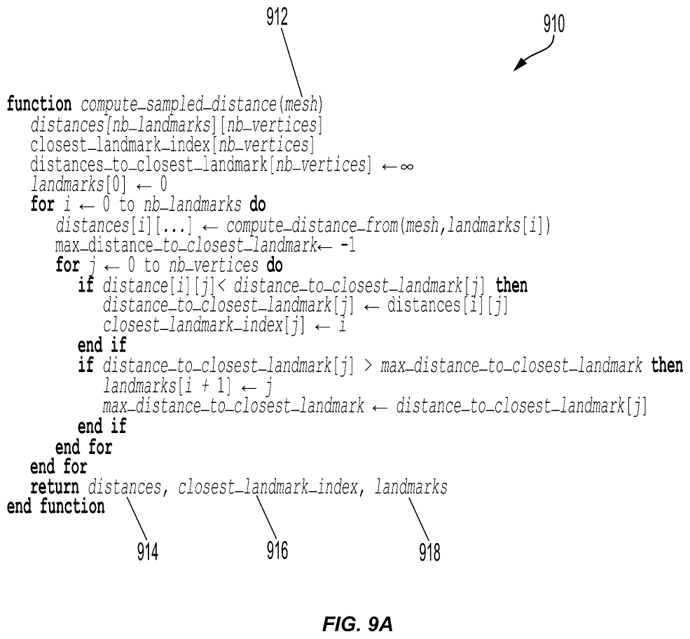

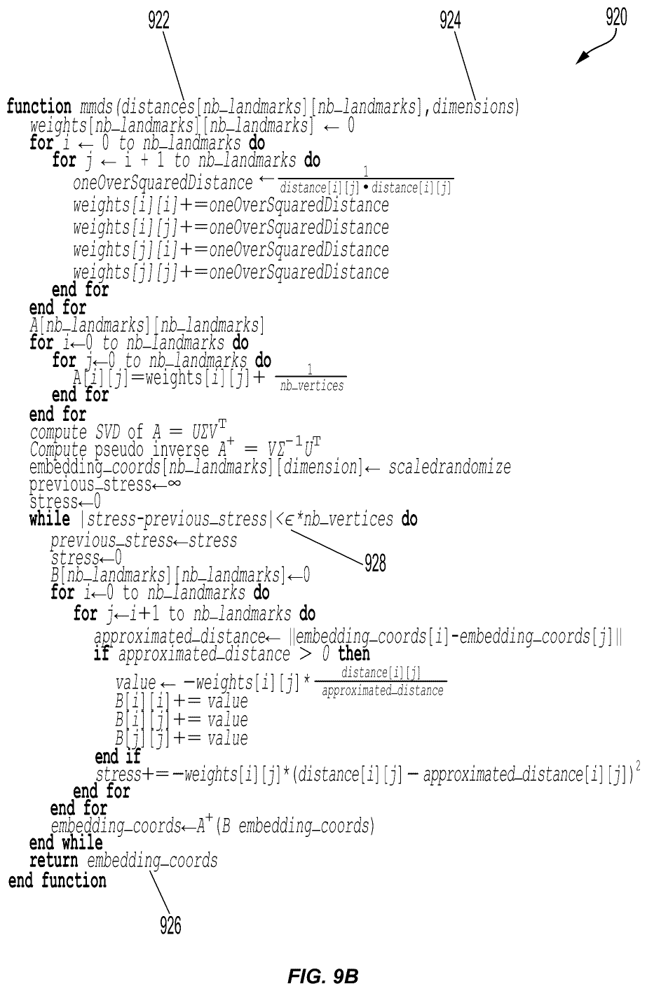

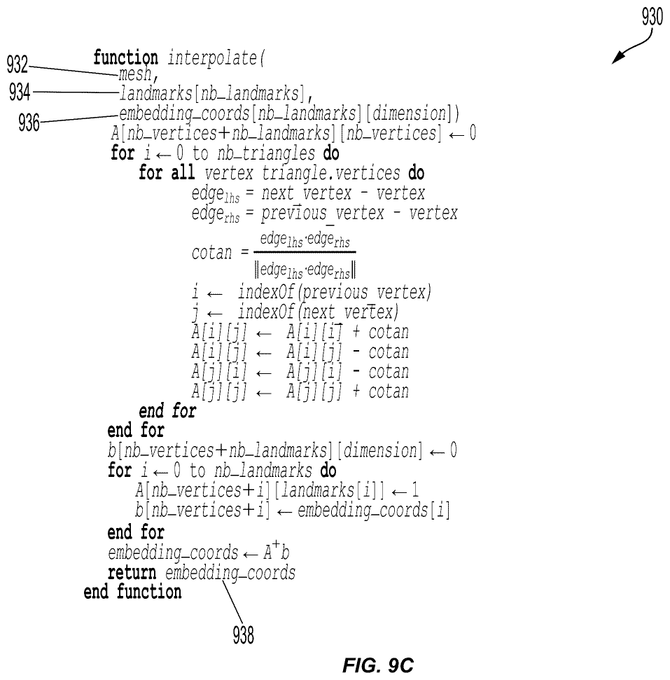

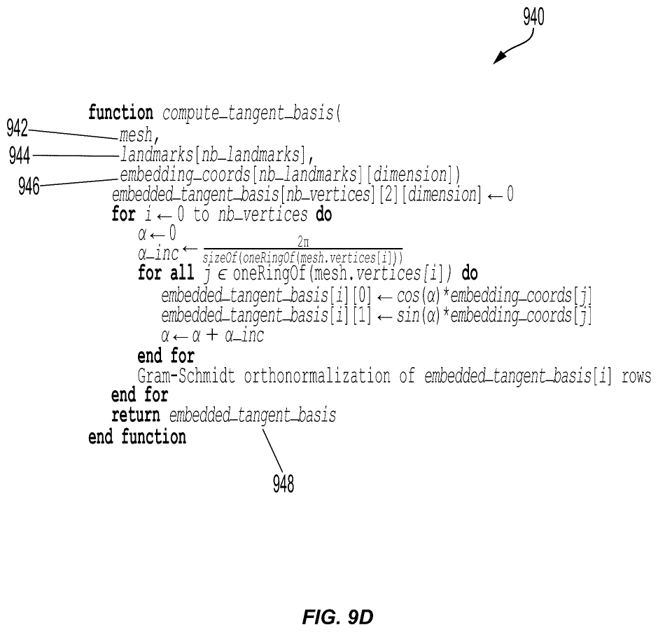

The mapping subsystem 110 includes pre-processing 140. Pre-processing 140 can include components for performing certain precomputations prior to determining the mapping from the 2D surface 130 to the 3D mesh 122 based on the 3D points 124 of the 3D mesh 122. For example, the computation of the mapping may involve computation of distances among the 3D points 124 of the 3D mesh 122. Where computation of those distances may be computationally expensive or impractical to precompute or to store following precomputation, certain approximations may be used in order to optimize the efficiency of the mapping generation and to achieve near-real-time interactivity. For example, an embedded representation (e.g., an embedded vector) of some or all of the 3D points 124 of the 3D mesh 122 can be used for efficient computation of distances. A detailed description of one implementation of pre-processing 140 is shown below in FIGS. 8-9D.

The mapping subsystem 110 includes anchor point input 150. The anchor point input 140 can be used to receive selections of 2D anchor points 135 from among the number of 2D points 133. For example, the GUI 105 may provide an interface that can be used to select 2D anchor points 135 within the domain of the 2D surface using a suitable input device (e.g., a mouse). The selections thus made can be received by the anchor point input 150 component.

For each 2D anchor point thus selected, the GUI 105 is used to select a corresponding 3D anchor point 126 from among the 3D points 124 of the 3D surface 120. The selected 3D anchor points 126 can be any 3D point on the 3D surface 120, including, but not limited to, vertices of the 3D mesh 122. For example, the GUI 105 may provide an interface that can be used to select 3D anchor points 126 on the 3D surface 120 using a suitable input device (e.g., a mouse). The selections thus made are received by the anchor point input 150 component and create a pair of anchor points, each including a 2D anchor point 135 and a corresponding 3D anchor point 126. These anchor point pairs “pin” the 2D surface 130 to the 3D surface 120 and provide the boundary conditions for the mapping computation. In some examples, the selected 3D anchor points 126 may be identified using barycentric coordinates of the polygonal faces of the 3D mesh 122.

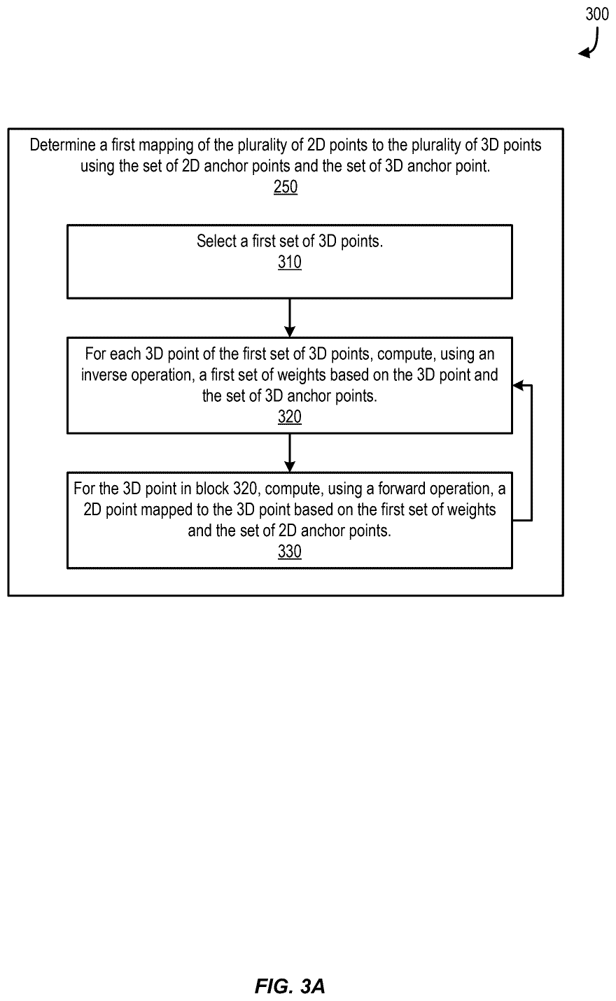

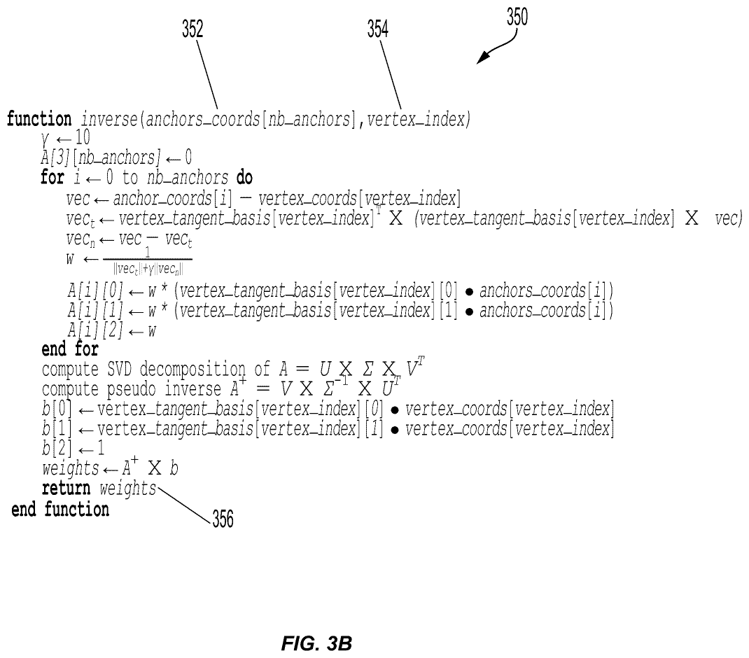

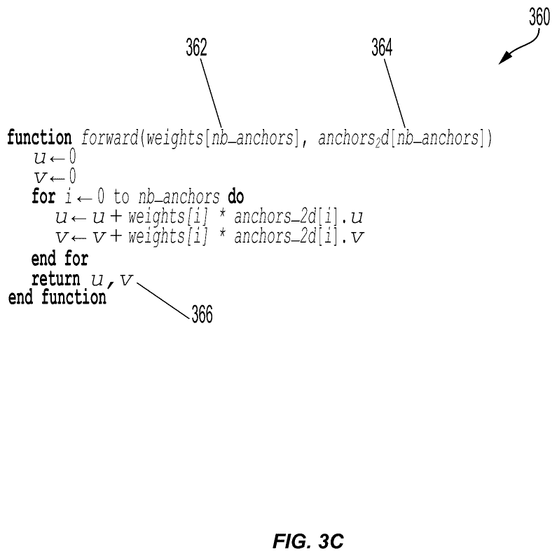

The mapping subsystem 110 includes mapping engine 155. The mapping engine 155 includes components for computing the parameterization of the 3D surface 130 by determining a mapping of the 2D points 133 to the 3D points 124 using the set of 2D anchor points 135 and the set of 3D anchor points 136 as inputs, as well as the intermediate outputs of pre-processing 140. Determining the mapping may involve parallel computation of the mapping by, for example, selecting subsets of 3D points 124 and computing the mapping for each subset in parallel. Computation of the mapping includes computing for each 3D point 124, a set of weights using an “inverse operation” and then the mapped 2D point 133 based the weights using a “forward operation.” These operations are based on a “weighted averages on surfaces” method that is computed using the selected anchor points 126, 135. These operations are discussed in detail below with respect to FIGS. 3A-3C.

The mapping subsystem 110 includes image output 160. The image output 160 includes components for rendering the 3D mesh 122 including the mapped 2D surface 130, as well as any other mapped textures, coloring, 2D surfaces, lighting effects, and so on. The image output 160 may be, for example, a component of a 3D graphics editing suite into which the techniques for mapping 2D surfaces to 3D surfaces based on corresponding anchor point described herein have been integrated. In some examples, the techniques are implemented with optimized efficiency using parallelization and enable near-real-time parameterization and interactivity. The rendered 3D mesh 122 is displayed on GUI 105, which is depicted in system 100 as same GUI 105 used for selection of anchor points above, but may be, in some examples, a different GUI.

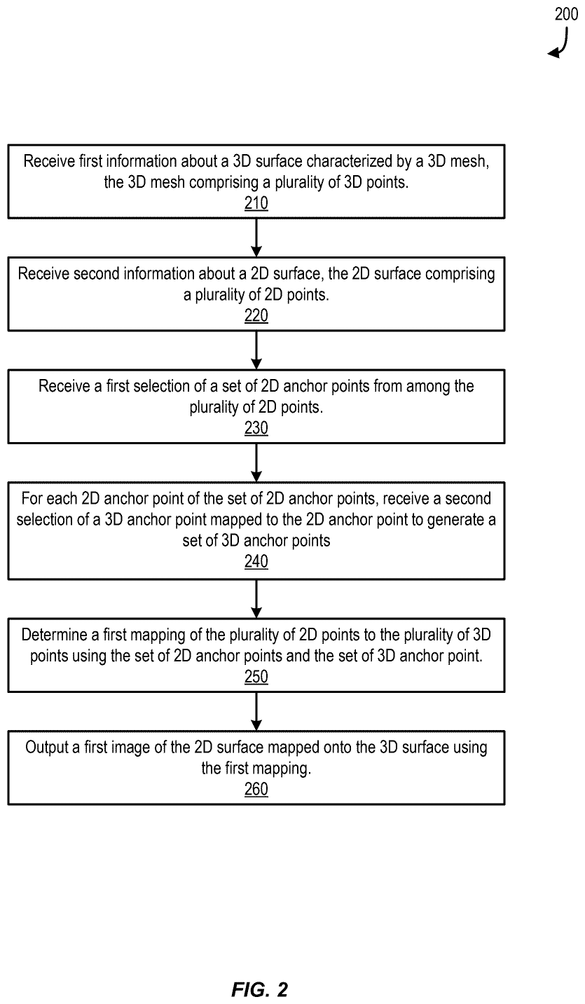

FIG. 2 is a flow diagram of an example process 200 for mapping 2D surfaces to 3D surfaces based on corresponding anchor points, according to some aspects of the present disclosure. The process 200 depicted in FIG. 2 may be implemented in software executed by one or more processing units of a processing device, implemented in hardware, or implemented as a combination of software and hardware. This process 200 is intended to be illustrative and non-limiting. The example process herein is described with reference to the mapping subsystem 110 of system 100 depicted in FIG. 1, but other implementations are possible. Although FIG. 2 depicts various processing operations occurring in a particular order, the particular order depicted is not required. In certain alternative embodiments, the processing may be performed in a different order, some operations may be performed in parallel, or operations may be added, removed, or combined together.

At block 210, a computing system, such as mapping subsystem 110 of system 100, receives first information about a 3D surface characterized by a 3D mesh, the 3D mesh including a number of 3D points. For example, a 3D graphic artist providing inputs using a GUI, such as GUI 105, may create or select a 3D surface defined by a 3D mesh. The 3D mesh may include a collection of connected 3D points (also referred to as vertices) that define the 3D surface. The collection of connected 3D points define the faces of the 3D mesh, which can be triangles or any other polygon. In some examples in which the faces of the 3D mesh are polygons other than triangles, the polygons can be “triangulated” (e.g., each polygon is redefined using two or more triangles). In this case, the mapping described in process 200 is performed using the redefined triangular faces. Generation of the output image described in block 260 below may use the original 3D mesh with non-triangular faces. The 3D points of the 3D mesh can be identified using their 3D coordinates.

In some examples, the 3D points of the 3D mesh may be identified using barycentric coordinates of the faces of the 3D mesh.

At block 220, the computing system receives second information about a 2D surface, the 2D surface including a number of 2D points. For example, a 3D graphic artist providing inputs using a GUI, such as GUI 105, may create or select a 2D surface or decal using the GUI. The mapping subsystem 110 can interface with a library or database of saved decals or the artist may create a new 2D decal. The 2D surface can be transformed (e.g., scaled, rotated, cropped, etc.) following selection in accordance with the desired mapping to the 3D mesh. For instance, the artist may desire to map a shape contained in a rectangular image to the 3D mesh and may, accordingly, crop out the background of the shape to obtain a 2D surface that has the desired shape, size, orientations, etc. In some examples, the 2D surface can be characterized by a particular domain, which may include a subset of 2D points included in a boundary.

At block 230, the computing system receives a first selection of a set of 2D anchor points from among the number of 2D points. For example, a 3D graphic artist providing inputs using a GUI, such as GUI 105, can select one or more 2D anchor points on the 2D surface identified in block 220. The 2D anchor points may be the 2D points on the 2D surface that should be pinned to particular locations, or 3D anchor points, on the 3D mesh.

At block 240, the computing system, for each 2D anchor point of the set of 2D anchor points, receives a second selection of a 3D anchor point mapped to the 2D anchor point to generate a set of 3D anchor points, in which each 2D anchor point has a corresponding 3D anchor point. In some examples, the mapping of each 2D anchor point to a 3D anchor point can be represented using a collection of ordered pairs, each ordered pair including a 2D anchor point and a corresponding mapped 3D anchor point. Again, using a GUI, such as GUI 105, a 3D anchor point can be selected on the 3D mesh for each 2D anchor point selected in block 230. The 3D anchor points may be, for example, vertices of the 3D mesh. In some examples, the 3D anchor points may be points on the interior of the faces of the 3D mesh, such as points in triangular mesh faces identified using barycentric coordinates.

Some examples may be configured to require a minimum or maximum number of anchor point pairs. For example, a minimum number of anchor point pairs (e.g., 3) may be required to attain a minimal accuracy of the computed mapping. The minimum number of anchor points may also be required to ensure the mathematical solvability of the mapping described in the following blocks. Likewise, a maximum number of anchor point pairs (e.g., 1,000) may be required to ensure a desired level of efficiency and speed of interactivity.

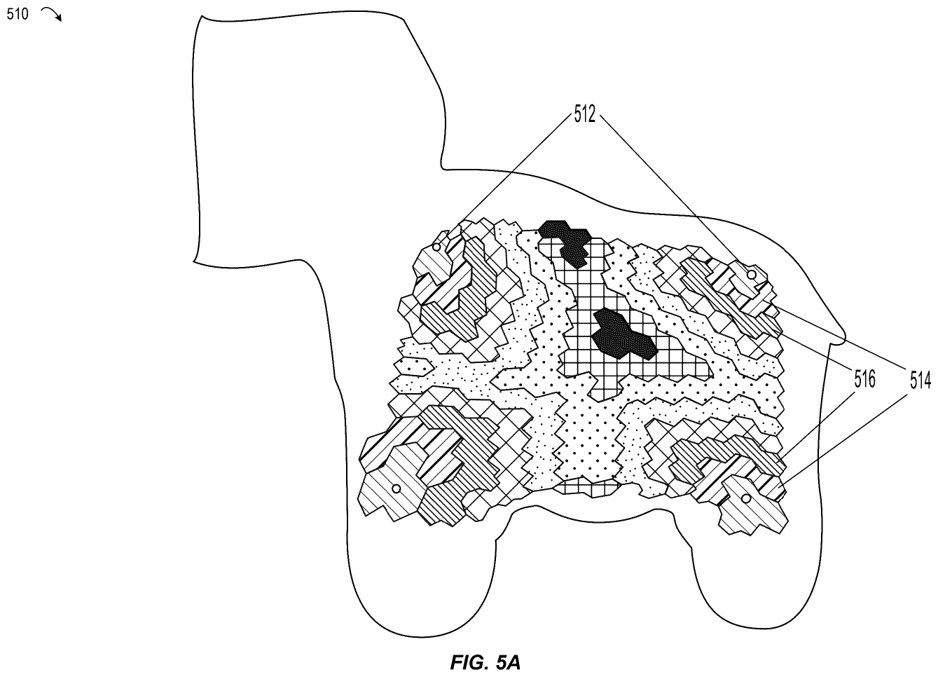

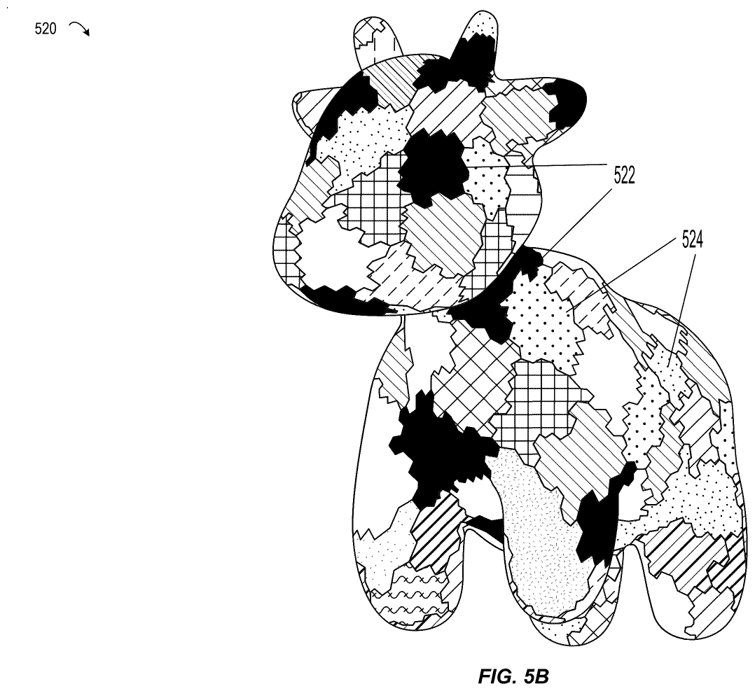

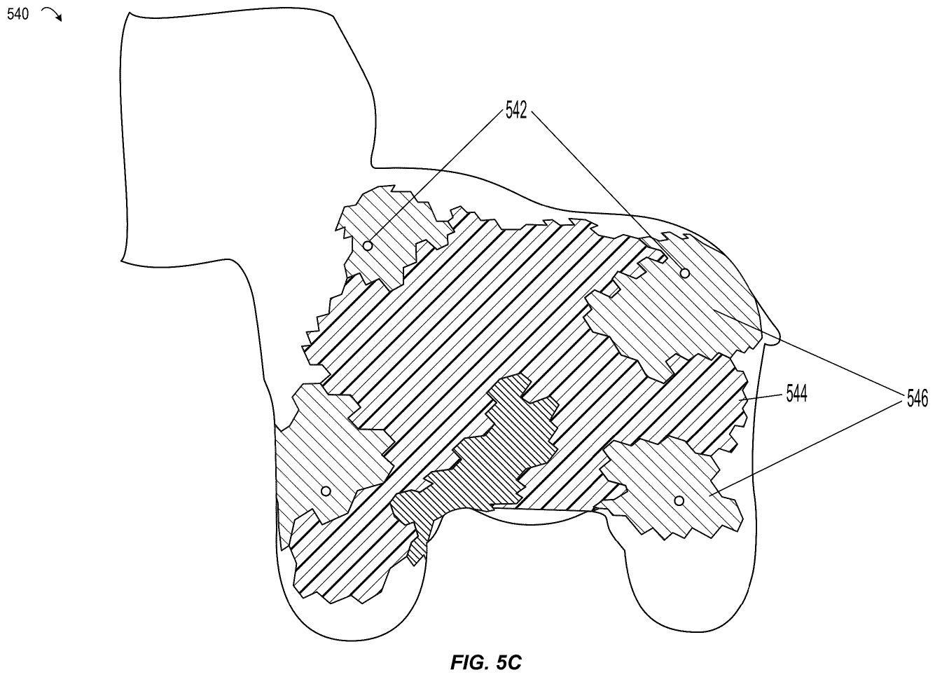

At block 250, the computing system determines a first mapping of the number of 2D points to the number of 3D points using the set of 2D anchor points and the set of 3D anchor points. In some examples, the mapping is computed using subsets of the 3D points on the 3D mesh for which mappings can be computed in parallel. In these examples, computing the mapping may involve first selecting one or more subsets of the 3D points of the 3D mesh according to a particular selection policy. For each 3D point of each subset, a 3D inverse operation can be used to determine the weights that would be required for the 3D anchor points to obtain the 3D point as a weighted average on the surface or mesh. Then, a 2D forward operation can be used to determine a 2D point by assigning the computed weights to the corresponding 2D anchor points and computing the weighted average on the surface or mesh. One or more next subsets can then determined according to the selection policy. Descriptions of example selection policies are described below in FIGS. 5A-7B. One example implementation of a process for computing the forward and inverse operations is described below in FIG. 3A.

At block 260, the computing system outputs a first image of the 2D surface mapped onto the 3D surface using the first mapping. For example, the image output component 160 of system 100 can be used to render the 3D mesh with the 2D surface applied to the 3D mesh according to the parameterization computed above. The rendering may also include other textures, shapes, lighting effects, and so on. In some examples, the graphic artist may make adjustments to the anchor points as described in blocks 230 and 240 to cause re-computation of the mapping. The rendering of the updated mapping may then occur in near-real-time.

FIG. 3A is a flow diagram of an example process 300 for determining a mapping of the 2D points to 3D points using the set anchor points as part of mapping 2D surfaces to 3D surfaces based on corresponding anchor points, according to some aspects of the present disclosure. The process 300 depicted in FIG. 3A may be implemented in software executed by one or more processing units of a processing device, implemented in hardware, or implemented as a combination of software and hardware. This process 300 is intended to be illustrative and non-limiting. The example process herein is described with reference to the mapping subsystem 110 of system 100 depicted in FIG. 1, but other implementations are possible. Although FIG. 3 depicts various processing operations occurring in a particular order, the particular order depicted is not required. In certain alternative embodiments, the processing may be performed in a different order, some operations may be performed in parallel, or operations may be added, removed, or combined together.

Process 300 is an example implementation of a process for determining the first mapping of the number of 2D points to the number of 3D points using the set of 2D anchor points and the set of 3D anchor points, as described in block 250 with respect to FIG. 2 above. Process 300 may be used to compute the mapping for one or more 3D points and in some examples, may be executed in parallel on one or more subsets of 3D points selected according to a selection policy or selection technique, as described below.

At block 310, a computing system, such as mapping subsystem 110 of system 100, selects a first set of 3D points. The 3D points may chosen according to a particular selection policy or selection technique. Various selection policies may be used according to the requirements of embodiments.

For example, one example selection policy is a greedy vertex parallel policy. The greedy vertex parallel policy receives as input a number of neighboring seed vertices surrounding the 3D anchor points. Following computation of the mapping from these 3D points to 2D points, as described in detail in the following blocks, the 3D points to use for the subsequent computation (i.e., the next subset of the 3D points) are selected by selecting the vertices surrounding each seed vertex. This process can continue recursively until the decal domain is almost fully or fully covered. For example, in the next iteration, the neighboring seed vertices surrounding the 3D anchor points become the 3D points to use for the next mapping step. A graphical depiction of this selection policy is shown in FIG. 5A below.

Another example selection policy is a greedy patch parallel policy. The greedy patch parallel policy can use as the subsets a collection of 3D points defined by a surface partitioning of the 3D mesh. For example, the pre-processing component 140 can generate a surface partitioning following selection of the 2D and corresponding 3D anchor points that can be used in concert with the greedy patch parallel policy. In the greedy patch parallel policy, each batch to map in parallel includes the union of the set of vertices in one or more active patches. As with the greedy vertex parallel policy, this process can continue recursively until the decal domain is almost fully or fully covered. For example, in the next iteration, the set of vertices in one or more adjacent patches become the 3D points to use for the next mapping step. A graphical depiction of this selection policy and a surface partitioning examples are shown in FIGS. 5B-C below.

In some examples, execution of the mapping using the example selection policies just described may not result in the decal domain being fully covered. For instance, the mapping problem may be constrained by the geometry of the 3D mesh (e.g., an irregularly shaped 2D decal mapped onto a 3D hemispherical surface may not be fully mapped if some portions of the mapped decal domain extend beyond the boundaries of the hemisphere's rim).

In some examples, the decal domain may be overestimated by the selection policy algorithm. For example, in some greedy vertex parallel policy implementations, some of the neighboring seed vertices selected for a next iteration of the selection algorithm may fall outside the decal domain. Likewise, in the greedy patch parallel policy some portions of adjacent patches selected for a next iteration of the selection algorithm may fall outside the decal domain.

The mapping of the 3D points of the 3D mesh to the 2D points of the 2D surface, described in the next two blocks, are based on computations relating to weighted averages. Weighted averages refer generally to determination of the position of a point as a combination of multiple points, in which each point's contribution to the final position is scaled by a specific weight. Operations relating to weighted averages may involve both forward and inverse operations. In general, the forward operation and inverse operation as used herein can refer forward and inverse computations relating to the weighted average on the surface. The forward operation can involve determining a point that is a weighted average on the surface given a collection of points and associated weights. The inverse operation can involve computing the weights given the collection of points and a point that would be the weighted average on the surface of the collection of points and the weights to be computed.

At block 320, the computing system, for each 3D point of the first set of 3D points, computes, using an inverse operation, a first set of weights based on the 3D point and the set of 3D anchor points. The inverse operation can be performed independently for each 3D point as a constrained moving least square problem with three constraints. In the constrained moving least square problem, two out of the three constraints can model a Phong projection constraint and the last constraint “softly” enforces the weights' normalization by requiring that the weight sum to 1. For example, for a given 3D point on the 3D mesh, the Phong projection constraint can be modeled by finding the weights which would yield a zero dot product of each of the 2 tangent basis vectors with the vector defined by the given 3D point and the weighted average of the 3D anchors in the embedding space. The under-constrained moving least square problem includes a 3×n_{anchors} system of linear equations. The system of linear equations can be solved using various approaches. For example, one approach sometimes referred to as the “fast policy” can be based on 3×3 normal equations solved using Cholesky factorization. The 3×3 normal equations can be obtained by deriving a symmetric positive definite matrix from the 3×n_{anchors} system of linear equations. Cholesky factorization can include decomposition of a matrix representing the system of linear equations into the product of a lower triangular matrix and its conjugate transpose. In another approach sometimes referred to as the “precise policy” for solving the system of linear equations, the pseudo-inverse of a matrix representing the system of linear equations can be used based on a singular value decomposition of the matrix. These or other approaches may be used in accordance with the efficiency and accuracy requirements for the particular application. In some examples, the precise policy may result in improved robustness.

FIG. 3B shows example implementation 350 of the 3D inverse operation, according to some examples of the present disclosure. The example implementation 350 is shown in pseudocode. Pseudocode, as shown and described in this and several following figures, is provided to illustrate the logic and steps involved operations implemented in program code (e.g., hardware or software). Pseudocode can be implemented in any or several of various programming languages, such as Python, C++, or JavaScript. While the pseudocode provided outlines one possible implementation, these examples are not intended to be limiting and are provided to show certain example embodiments. The example implementation 350 receives as input the first set of weights 362 determined in block 320 and the set of 2D anchors points 364. The implementation 360 outputs the uv coordinates of a 2D point 366 using the method described above in block 330.

At block 330, the computing system computes, using a forward operation, a 2D point mapped to the 3D point of block 320 based on the first set of weights and the set of 2D anchor points. In some examples, the forward operation can be solved using a closed, robust, deterministic, and efficient form. The closed form is based on the observation that, given a set of 2D points and associated weights, the Frechet mean can be determined based on the weighted average of these 2D points. The Frechet mean is a generalization of the arithmetic mean for points in a metric space, such as the 2D space of the decal. It is defined as the point that minimizes the sum of squared distances to a given set of weighted points. In 2D space, the Frechet mean simplifies to the classical arithmetic mean, which may be computationally efficient to implement.

FIG. 3C shows example implementation 360 of the 2D forward operation, according to some examples of the present disclosure. The example implementation 360 is shown in pseudocode. The implementation 360 receives as input the first set of weights 362 determined in block 320 and the set of 2D anchors points 364. The implementation 360 outputs the uv coordinates of a 2D point 366 using the method described above in block 330.

Turning now to FIG. 4, FIG. 4 depicts a GUI 400 that can be used with some examples of mapping 2D surfaces to 3D surfaces based on corresponding anchor points, according to some aspects of the present disclosure. The GUI 400 may be similar in some respects to the GUI 105 described with respect to system 100 of FIG. 1 above. The GUI 400 may be displayed on a display components of a suitable client device such as a laptop, desktop, smartphone, tablet, and so on. In some examples, the GUI 400 can be hosted as a web application and displayed and interacted with using a web browser. In that case, the web application may be hosted in a remote server such as a suitable component of the mapping subsystem 110. In some examples, the GUI 400 may be provided as a native application of the client device. For instance, the GUI 400 can be a component of a standalone application installed on the client device or a component of a collection of applications installed on the client device, such as a graphics editing suite of components.

The example GUI 400 includes top menus 405. The top menus 405 can include UI controls for various functions such as file-related functions and documentation access. The example GUI 400 shows an editing mode status display 407 that provides an UI indication of the mode of operation of the GUI 400 for the benefit of the graphic artist. In this example the editing mode status display 407 depicts a “Edit Control Points” which may correspond to, for example, selection of 2D or 3D anchor points as described in blocks 220 and 230 of process 200 above in FIG. 2. The example GUI 400 includes sidebar controls 410. The sidebar controls can include UI controls for various functions, settings, and configurations relating to the mode of operation of the GUI 400 as shown in the editing mode status display 407. In some examples, the sidebar controls 410 can include UI controls that are present for all or a subset of modes. In this example, functions and settings relating to image rendering are shown. The example GUI 400 includes navigation bar 415. Navigation bar 415 can display UI controls for navigation within, between, and among documents, images, projects, etc. In this example, the navigation bar 415 depicts a scene view. For example, a graphic artist drawing a scene may include multiple 3D objects, each of which can be used with mapping 2D surfaces to 3D surfaces based on corresponding anchor points.

The example GUI 400 includes 3D editing window 420. The 3D editing window 420 shows 3D surface 430. Likewise, GUI 400 includes 2D editing window 425 and 2D surface 440. 2D anchor points 445 are shown in 2D editing window 425 and the corresponding 3D anchor points 435 are shown in 3D editing window 420. The lead lines for 2D anchor points 445 and 3D anchor points 435 are shown as dashed lines for clarity. The 2D surface 440 is shown as mapped to the 3D surface 430 in the 3D editing window 420. In some examples, the GUI 400 can be interacted with in near-real-time. Thus, the GUI 400 may depict the mapping of 2D surface 440 to 3D surface 430 immediately following selection of or adjustment of one of the 2D or 3D anchor points 435, 445.

Turning next to FIGS. 5A-5C, FIGS. 5A-5C show graphical depictions of a 3D mesh during mapping of 2D surfaces to 3D surfaces based on corresponding anchor points, according to some aspects of the present disclosure. As explained in process 300 above, while determining the first mapping of the number of 2D points to the number of 3D points using the set of 2D anchor points and the set of 3D anchor points, the mapping subsystem 110 can selects a first subset of the 3D points of the 3D mesh. FIGS. 5A-5C show graphical depictions of example selection policies that can be used for selecting subsets of 3D points for mapping of 2D surfaces to 3D surface in parallel.

FIG. 5A shows a graphical depiction 510 of the greedy vertex parallel selection policy, according to some examples of the present disclosure. In the greedy vertex parallel selection policy, a number of neighboring seed vertices 512 surrounding the 3D anchor points are identified. Following computation of the mapping from these 3D points to 2D points the 3D points to use for the subsequent computation (i.e., the next subset of the 3D points) are selected by selecting the vertices surrounding each seed vertex. The vertices surrounding each seed vertex can be referred to as the “one ring” surrounding the vertex. Depiction 510 shows 4 seed vertices 512 with expanding concentric rings 514, 516 surrounding each seed vertex 512. The concentric rings 514, 516 each represent a “batch” or subset of 3D points that can be mapped to 2D points in parallel. Only two pairs of example concentric rings 514, 516 of vertices are labeled for clarity. In effect, a “propagating front” of vertices for mapping emanates from each seed vertex 512 as the mapping proceeds.

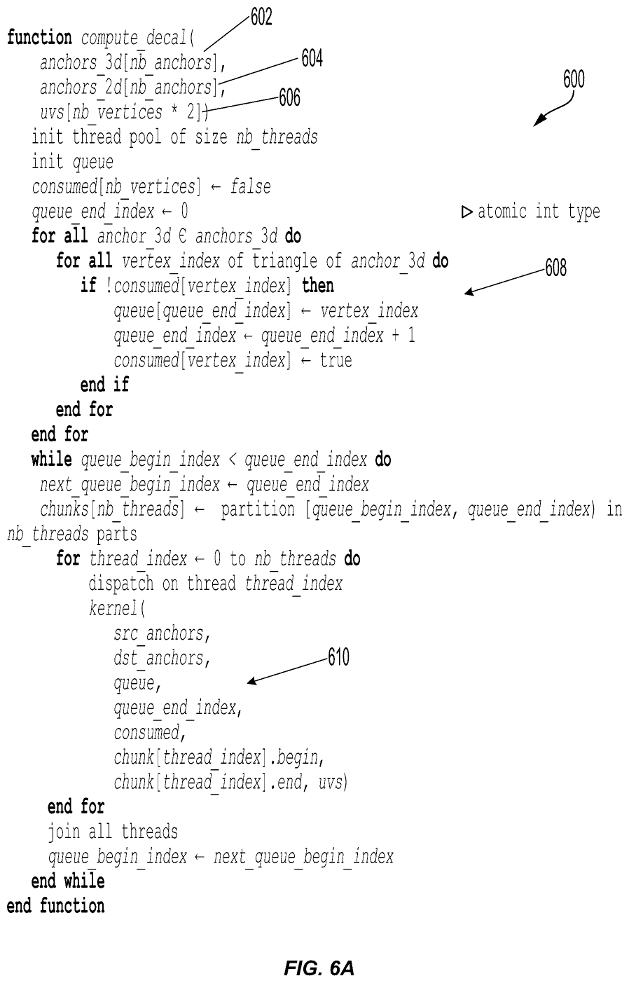

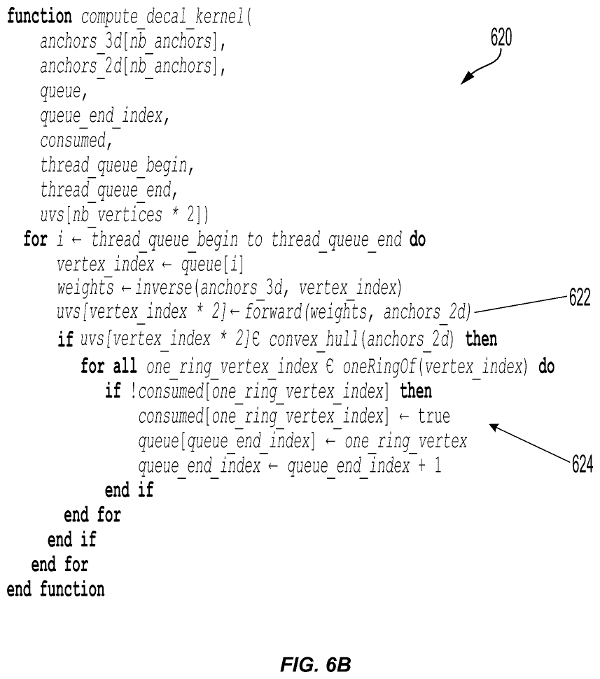

FIG. 6A shows an example implementation 600 of the greedy vertex parallel selection policy, according to some examples of the present disclosure. The example implementation 600 is shown in pseudocode. The implementation 600 receives as input the 2D anchor points 604 and the corresponding 3D anchor points 602 and a reference to an array of 2D points to receive the mapped 2D coordinates 606. The implementation 600 determines the “one ring” subsets at 608 and then performs the mapping steps in parallel at 610. FIG. 6B shows an example implementation 620 of the mapping step 610 in a separate function, for clarity. The 3D inverse operation, as described in block 320 with respect to FIG. 3, is executed at 622. An example implementation of the 3D inverse function is shown in FIG. 3B. At 624, the boundary propagation of the mapping is controlled by checking for a predefined boundary condition such as checking for inclusion of the mapped 2D point in the decal domain, defined as, for example, the convex hull of the set of 2D anchor points. Other definitions of the decal domain can be used. For instance, some examples may use classical box testing, in which a mapped 2D point is considered in the decal domain when it falls within the unit square [0,1]². These checks can enable the classification of a parameterized vertex as being inside or outside the 2D surface and thus control the boundary propagation.

FIG. 5B shows a graphical depiction 520 of a surface partitioning that may be used by some implementations of the greedy patch parallel selection policy, according to some examples of the present disclosure. The depiction 520 shows one example surface partitioning including a large, monolithic partition 524 and a multi-part partition 526 that includes several disparate parts. The surface partitioning can be determined using the 3D anchor points 522 during pre-processing using, for example, the process described below in process 800 with respect to FIG. 8. However, other procedures for establishing a surface partitioning may be used as well.

Turning now to FIG. 5C, FIG. 5C shows a graphical depiction 540 of the greedy patch parallel selection policy, according to some examples of the present disclosure. In the greedy patch parallel selection policy, the subsets of the collection of 3D points are defined using a strategy to identify “patches” 542, 544 of nearby vertices to map in parallel. For example, during pre-processing of the selected 2D/3D anchor point pairs, a surface partitioning of the 3D mesh can be generated in concert with some other pre-processing steps. Each patch 542, 544, or subset of the 3D points, to map in parallel can include the union of the set of vertices in one or more active patches. In some examples, the greedy patch parallel selection policy may use significantly fewer batches in comparison with the greedy vertex parallel selection policy due to coarser granularity of the patches 542, 544. Consequently, the greedy patch parallel selection policy may result in better CPU utilization for some applications. Depiction 540 shows two pairs of patches 542, 544 labeled for clarity. However, in implementations, the mappings for all patches of a given color can be executed in parallel.

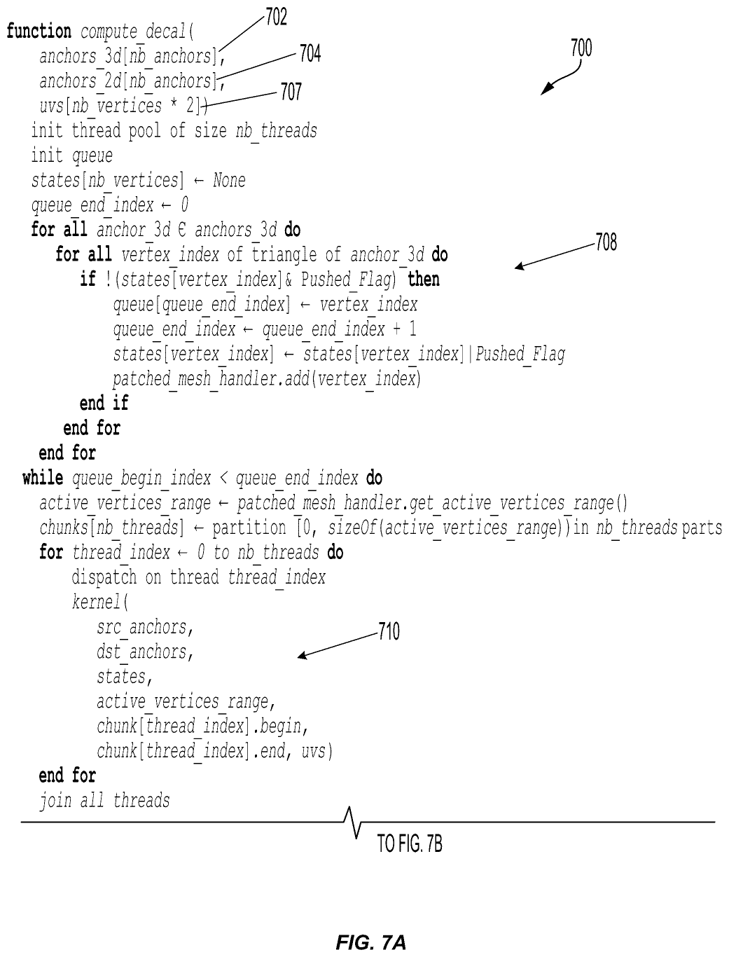

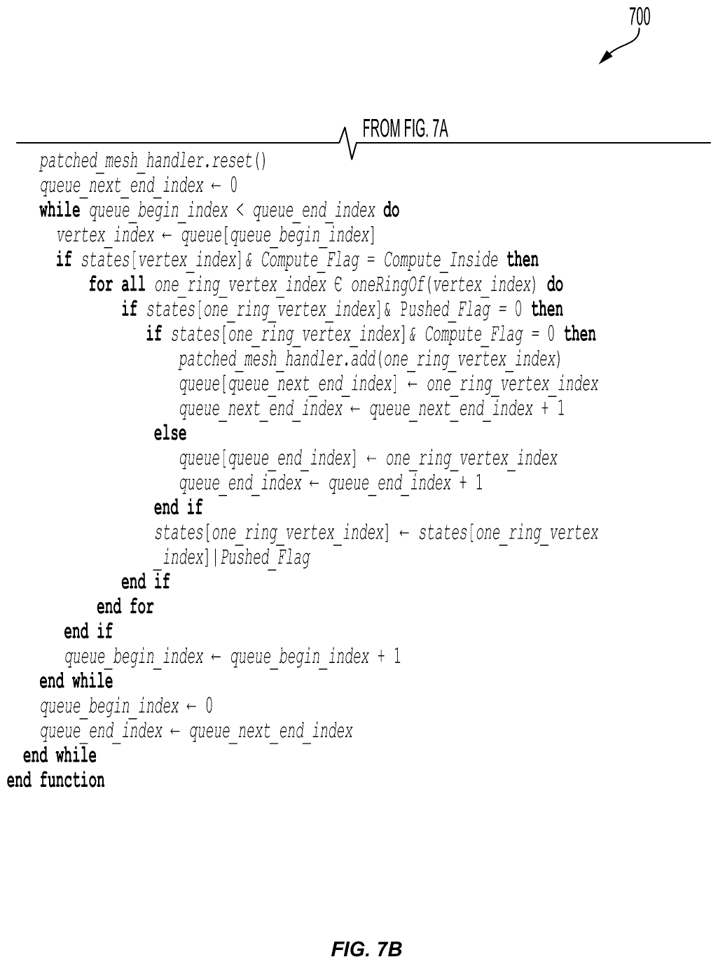

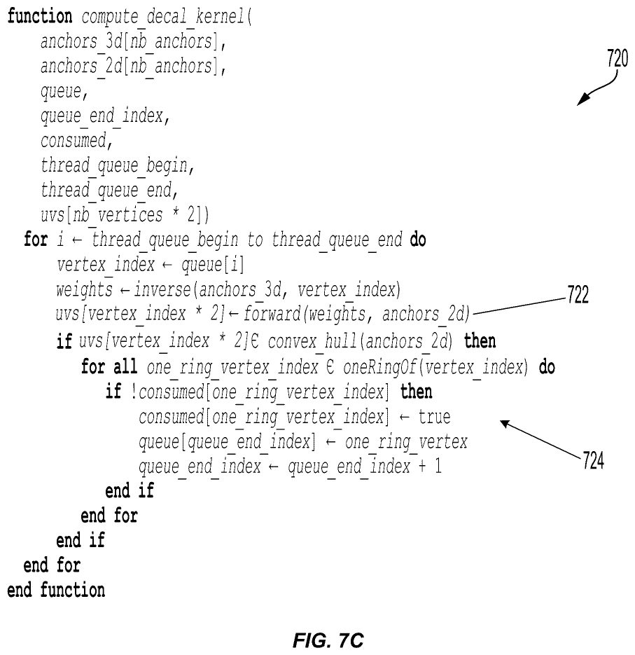

FIGS. 7A-B shows an example implementation 700 of the greedy patch parallel selection policy, according to some examples of the present disclosure. The example implementation 700 is shown in pseudocode. The implementation 700 receives as input the 2D anchor points 704 and the corresponding 3D anchor points 702 and a reference to an array of 2D points to receive the mapped 2D coordinates 706. The implementation 700 populates the patches with vertices at 708 and then performs the mapping steps in parallel at 710. FIG. 7C shows an example implementation 720 of the mapping step 710 in a separate function, for clarity. The 3D inverse operation, as described in block 320 with respect to FIG. 3, is executed at 722. An example implementation of the 3D inverse function is shown in FIG. 3B. At 724, the boundary propagation of the mapping is controlled by checking for a predefined boundary condition such as checking for inclusion of the mapped 2D point in the decal domain, defined at the 2D to be the convex hull of the set of 2D anchor points. This check can enable the classification of a parameterized vertex as being inside or outside the 2D surface and thus control the boundary propagation.

FIG. 8 is a flow diagram of an example process 800 for preprocessing the 3D points of a 3D mesh as part of mapping 2D surfaces to 3D surfaces based on corresponding anchor points, according to some aspects of the present disclosure. The process 800 depicted in FIG. 8 may be implemented in software executed by one or more processing units of a processing device, implemented in hardware, or implemented as a combination of software and hardware. This process 800 is intended to be illustrative and non-limiting. The example process herein is described with reference to the mapping subsystem 110 of system 100 depicted in FIG. 1, but other implementations are possible. Although FIG. 8 depicts various processing operations occurring in a particular order, the particular order depicted is not required. In certain alternative embodiments, the processing may be performed in a different order, some operations may be performed in parallel, or operations may be added, removed, or combined together.

Some computational elements (e.g., the inverse operation described above with respect to block 320 of FIG. 3) can be based on the run-time evaluation of distances between any pair of 3D points on the 3D mesh. Consequently, efficient computation of the distance between any pair of 3D points on the 3D mesh is needed for real-time performance or interactivity. Pre-computation of all pairwise distances is generally impractical. For example, pre-computation of all pairwise distances for all 3D points of a 3D mesh would require storing a half dense matrix of all pre-computed pairwise distances. Such a matrix would scale in proportional to n², where n is the number of 3D points in the 3D mesh. Both pre-computation and storage of such a matrix is impractical, particularly for production assets that may have hundreds of thousands of 3D points or more.

At block 810, a computing system, such as the mapping subsystem 110, determines a subset of the 3D points (or vertices) of the 3D mesh. In some examples, the pairwise distances between 3D points of the 3D mesh can be pre-computed for a subset of 3D points. The 3D points in the subset may be referred to as “landmarks.” Landmarks can be selected by, for example, using a “farthest point” sampling strategy. Other sampling strategies may be used to similar effect. For example, some domain-oriented sampling strategies may more effectively capture high frequencies (e.g., rapid changes) of the distance field on the 3D mesh. In such cases, the domain-oriented sampling strategies may allow for additional qualitative approximations that may improve efficiency when reconstructing the distance field using interpolation of the landmarks' embeddings, as described below.

In some examples, the farthest point sampling strategy to determine the landmarks may be implemented by first selecting a 3D point of the 3D mesh. The 3D point may be selected using a specified method or may be selected arbitrarily (e.g., randomly). The shortest path from the selected 3D point to all other 3D points of the 3D mesh can be then computed using, for example, Euclidean distance, graph distance, or geodesic distance. For instance, standard graph distances can be computed using the Dijkstra method by using edge lengths determined with the Euclidean distance between pairs of 3D points. In some examples, use of the geodesic distance can reduce distortion when the subsequent parameterization is computed.

At block 820, the computing system generates a matrix including the pairwise distances between each landmark and each vertex. For example, given the subset of 3D points, or landmarks, a matrix of containing pairwise distances between the landmarks and all 3D points can be constructed (e.g., a “thin” matrix). The thin matrix can have dimensions of n_{vertices}×n_{landmarks}. Each column of index i of the thin matrix, then, can include the distances from the landmark i to all 3D points of the 3D mesh. The rows of the thin matrix not including a landmark can be pruned, resulting in a square matrix of pairwise distances with dimension n_{landmarks}×n_{landmarks} with a zero diagonal.

The collection of shortest paths thus computed can be used as the column of an intermediate n_{vertices}×1 matrix. The next 3D point can be chosen as one that maximizes the distance to all previous landmarks. This selection can be implemented, for example, using an algorithm that computes the maximum element of the min reduction “distance to closest landmark” of all previous shortest paths. For example, given n computed shortest paths for n landmarks arranged as columns, the min reduction would be a new column that includes, for each row, the minimum of each row of the thin matrix generated above. The index of the vertex representing the next landmark is, in this example, the row index containing the maximum value of the new column.

The selection of the next 3D point can be followed by computation of the shortest paths, resulting in an intermediate n_{vertices}×2 matrix, and so on, until the desired number of landmarks has been selected. By repeating this process until the desired number of landmarks has been selected, a n_{vertices}×n_{landmarks} distance matrix can be thus produced. In some examples, 128 landmarks can be used which can result in optimized efficiency for near-real-time interactivity.

In addition to the n_{vertices}×n_{landmarks} distance matrix, a partitioning of the 3D mesh can be obtained during this phase of the preprocessing by noting, at each iteration, which landmark induced the minimal distance in the reduction in the array closest landmark index. Continuing the example above involving n computed shortest paths for n landmarks and the new column, an additional column can be included that corresponds to the index of the landmark from which the minimum distance originates. This additional constructed column can be used to partition the vertices of the 3D mesh according to the closest landmark for each vertex as compared with all other landmarks.

FIG. 9A shows an example implementation 910 of the farthest point sampling strategy and generation of the distance matrix, according to some examples of the present disclosure. The example implementation 910 is shown in pseudocode. The implementation 910 receives as input the 3D points of the 3D mesh 912, as, for example, an array of vectors or comparable tuple objects. The implementation 910 outputs a matrix or 2D array of the computed distance between each landmark and each vertex 914, an array identifying the landmark that is closest to each vertex 916, and an array of the determined landmarks 918 as vectors or other comparable tuple objects.

At block 830, the computing system reduces the matrix. In some examples, the square pruned thin matrix is symmetric due to the commutative nature of the distance operator. However, in some other examples, the symmetry of the resultant square matrix may be lost due to accumulated numerical round-offs during distance pre-computation. In this case, this lower and upper part of the square matrix can be averaged together. The result of the averaging operation can be stored, for example, in the lower part of the square matrix or in a newly created matrix. Some examples may store the average in the upper part. In the former case, for example, elements of the upper part can be referenced using values from the lower part by permuting (e.g., swapping) the row and column indices of the corresponding lower part distance to fetch the distance from the upper part.

At block 840, the computing system generates an embedded vector for each column of the reduced matrix, where each column corresponds to a landmark, using a multidimensional scaling process. The square pruned thin matrix can be used to generate an embedded vector for each landmark, corresponding to each column of the square pruned thin matrix. For example, a metric multidimensional scaling process can be used to generate an n-D vector for each landmark representing the landmark's embedded coordinates. For instance, an 8D vector can be generated for each landmark. Various examples may use different number of dimensions for the embedded vectors. Determination of the number of dimensions for the embedded vectors can be empirically determined using test decals under varying conditions.

The metric multidimensional scaling process can be implemented using any suitable method from the metric multi-dimensional scaling family of methods for reduction of the columns of the square pruned thin matrix. Some examples may use, for instance, the “Scaling by MAjorizing a COmplicated Function” (“SMACOF”) algorithm. The SMACOF algorithm includes an objective function that is well suited to determining geodesic distances using an inverse distance weighting scheme that can favor local qualities of the distance approximation over global qualities. Some implementations of determination of the mapping may rely on a constrained moving least square regression for determining the generalized weights of a 3D point on the 3D mesh (e.g., the inverse operation). Such algorithms result in a higher quality end result when the metric mapping procedure favors local rather than global correctness of the embedding. Some examples may use classical multidimensional scaling rather than metric multidimensional scaling, with no significant change to the resulting stress minimization (e.g., the resulting quality of the embedding).

FIG. 9B shows an example implementation 920 of a metric multidimensional scaling process, according to some examples of the present disclosure. The example implementation 920 is shown in pseudocode and may correspond to some SMACOF algorithm implementations. The implementation 920 receives as input the reduced array of pairwise distances among the landmarks 922 computed in block 830 as well as the desired number of dimensions for the embedded vectors 924. The implementation 920 outputs an array of embedded vectors 926 of dimension n_{landmarks}×dimensions. The implementation 920 includes a test for convergence during certain iterative computations. The convergence limit 928, ε, may be determined according to the accuracy requirements of the particular application. For instance, some examples may use an ε value of 10⁻⁵, but other values may be used. Some examples further include a limit the number of iterations during this loop (e.g., 10,000) to ensure that the desired experience of near-real-time interactivity is maintained when the comparison fails to converge.

At block 850, the computing system determines an embedded vector for each 3D points of the 3D mesh by determining the pairwise distance between all 3D points of the 3D mesh using the embedded vectors of the landmarks and an interpolation technique. The embedded vector can be used to efficiently approximate distances between 3D points on the 3D mesh. For example, the distance between any two landmarks can be computed using the Euclidean norm of the vector dᵢⱼ≈∥eᵢ−eⱼ∥, where eᵢ and eⱼ are the embedded coordinates of the landmarks. This formulation, when used in concert with pre-computation of distances, reduces the memory requirement for storing the embedded vectors to one that scales linearly with the number of landmarks. In some examples, embedded vectors for all 3D points of the 3D mesh can be obtained using an interpolation technique to between the embedded vector of 3D points located between landmarks. In that case, the memory requirement still scales linearly with the number of 3D points.

In one example interpolation technique, a sparse matrix of dimension [symbol] (n [symbol] _{vertices}+n_{landmarks})×n_{vertices} can be constructed. A sparse matrix is a matrix with a significant number of zero elements (e.g., 1% to 10% non-zero elements). The upper n_{vertices}×n_{vertices} portion of the sparse matrix can be set to the “cotangent Laplacian matrix.”. The cotangent Laplacian matrix can be determined by computing the average of, for each vertex, the embedded vectors of all connected vertices, sometimes referred to as the “one ring” of the vertex. A system of linear equations can be established in which the Laplacian matrix is on the left hand side and the right hand side can be set to zero. This can promote a smoothly varying (e.g., a smoothly varying topology) scalar field over the 3D mesh.

The lower n_{landmarks}×n_{vertices} portion of the system of equations thus created can be augmented with soft Dirichlet boundary conditions by appending to the system n_{landmarks} additional rows, in which each row includes of a single non-zero element of 1 on the column corresponding to the index of the landmark vertex on the left hand side and the transposed vector of the landmark's embedded coordinates on the right hand side. The final interpolated embedding for the full set of 3D points of the 3D mesh can be obtained by solving for this over-determined system of equations through a computation technique for solving systems of linear equations known in the art. Use of this topological approach to interpolation can be robust to degeneracies (e.g., thin triangles). Other approaches for interpolation, such as geometric interpolation may introduce some “stretch” in the reconstructed field proportionally to the irregularity of the tessellations of the 3D mesh.

FIG. 9C shows an example implementation 930 of a linear interpolation process, according to some examples of the present disclosure. The example implementation 930 is shown in pseudocode. The implementation 930 receives as input the array of 3D points of the 3D mesh 932, the array of landmarks 934, and the matrix of embedded vectors 936 of dimension n_{landmarks}×dimensions. The implementation 930 outputs a matrix of interpolated embedded vectors 938, now having dimensions n_{vertices}×dimensions.

At block 860, the computing system determines an embedded tangent basis for each 3D point of the 3D mesh. Some aspects of determining the mapping may involve use of an embedded tangent basis in the embedded vector space at each 3D point on the 3D mesh. An embedded tangent basis is a set of basis vectors that are defined at each point on a manifold and lie within the tangent space of the manifold at that point. In this example, each embedded tangent basis can be represented as a 2×n matrix for each 3D point. The embedded tangent bases can be used for, for example, modeling certain constraints during parameterization (e.g., while solving the inverse problem). Various approaches may be used for computation of the embedded tangent bases. For example, one approach involves computing Loop's limit stencil in [symbol] ^{dimension}. Other approaches may involve the use of geometric methods.

FIG. 9D shows an example implementation 940 of a process for determining the embedded tangent bases, according to some examples of the present disclosure. The example implementation 940 is shown in pseudocode. The implementation 940 receives as input the array of 3D points of the 3D mesh 942, the array of landmarks 944, and the matrix of embedded vectors 946 of dimension n_{vertices}×dimensions. The implementation 930 outputs a multidimensional matrix of embedded tangent bases 948 including an embedded tangent bases for each 3D point of the 3D mesh.

### Computing Environment

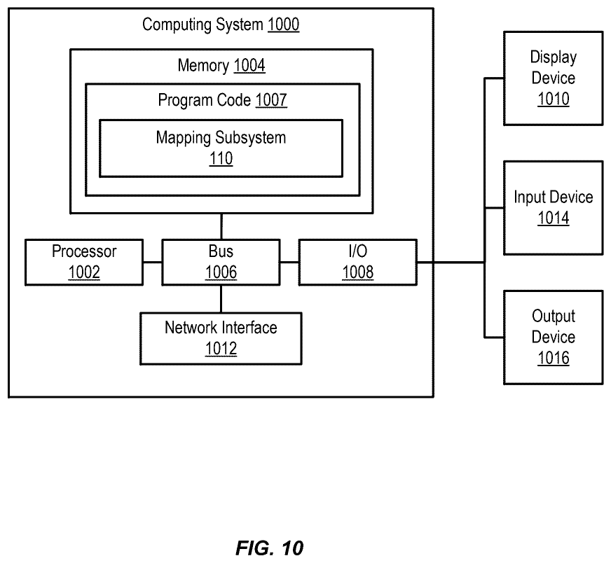

Any suitable computer system or group of computer systems can be used for performing the operations described herein. For example, FIG. 10 depicts an example of a computer system 1000 used in some examples for mapping 2D surfaces to 3D surfaces based on corresponding anchor points, according to some aspects of the present disclosure. The depicted example of the computer system 1000 includes a processor 1002 communicatively coupled to one or more memory devices 1004. The processor 1002 executes computer-executable program code stored in a memory device 1004, accesses information stored in the memory device 1004, or both. Examples of the processor 1002 include a microprocessor, an application-specific integrated circuit (“ASIC”), a field-programmable gate array (“FPGA”), or any other suitable processing device. The processor 1002 can include any number of processing devices, including a single processing device.

The memory device 1004 includes any suitable non-transitory computer-readable medium for storing program code 1007, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the memory device 1004 can be volatile memory, non-volatile memory, or a combination thereof.

The computer system 1000 executes program code 1007 that configures the processor 1002 to perform one or more of the operations described herein. Examples of the program code 1007 include, in various embodiments, the mapping subsystem 110 including the several components described in FIG. 1, which may include any other suitable systems or subsystems that perform one or more operations described herein (e.g., one or more ML models, storage systems, controllers, or function-specific modules). The program code 1007 may be resident in the memory device 1004 or any suitable computer-readable medium and may be executed by the processor 1002 or any other suitable processor.

The processor 1002 is an integrated circuit device that can execute the program code 1007. The program code 1007 can be for executing an operating system, an application system or subsystem, or both. When executed by the processor 1002, the instructions cause the processor 1002 to perform operations of the program code 1007. When being executed by the processor 1002, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory devices 1004 store the program code 1007 that includes one or more datasets described herein. In some embodiments, one or more of data sets are stored in the same memory device (e.g., one of the memory devices 1004). In additional or alternative embodiments, one or more of the programs, data sets, models, and functions described herein are stored in different memory devices 1004 accessible via a data network. One or more buses 1010 are also included in the computer system 1000. The buses 1010 communicatively couple one or more components of a respective one of the computer system 1000.

In some embodiments, the computer system 1000 also includes a network interface device 1012. The network interface device 1012 includes any device or group of devices suitable for establishing a wired or wireless data connection to one or more data networks. Non-limiting examples of the network interface device 1012 include an Ethernet network adapter, a modem, and/or the like. The computer system 1000 is able to communicate with one or more other computing devices via a data network using the network interface device 1012.

The computer system 1000 may also include a number of external or internal devices, an input device 1014, an output device 1016, or other input or output devices. For example, the computer system 1000 is shown with one or more input/output (“I/O”) interfaces 1008. An I/O interface 1008 can receive input from input devices or provide output to output devices. An input device 1014 can include any device or group of devices suitable for receiving visual, auditory, or other suitable input that controls or affects the operations of the processor 1002. Non-limiting examples of the input device 1014 include a touchscreen, a mouse, a keyboard, a microphone, a separate mobile computing device, etc. An output device 1016 can include any device or group of devices suitable for providing visual, auditory, or other suitable sensory output. Non-limiting examples of the output device 1016 include a touchscreen, a monitor, a speaker, a separate mobile computing device, etc.

Although FIG. 10 depicts the input device 1014 and the output device 1016 as being local to the computer system 1000, other implementations are possible. For instance, in some embodiments, one or more of the input device 1014 and the output device 1016 can include a remote client-computing device that communicates with computing system 1000 via the network interface device 1012 using one or more data networks described herein.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computer systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

### General Considerations

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included within the scope of claimed embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computer system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Additionally, the use of “based on” is meant to be open and inclusive, in that, a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method, comprising:
receiving first information about a three-dimensional (“3D”) surface characterized by a 3D mesh, the 3D mesh comprising a plurality of 3D points;
receiving second information about a two-dimensional (“2D”) surface, the 2D surface comprising a plurality of 2D points;
receiving a first selection of a set of 2D anchor points from among the plurality of 2D points;
for each 2D anchor point of the set of 2D anchor points, receiving a second selection of a 3D anchor point mapped to the 2D anchor point to generate a set of 3D anchor points;
determining a first mapping of the plurality of 2D points to the plurality of 3D points using the set of 2D anchor points and the set of 3D anchor points, comprising:
selecting a first set of 3D points; and
for each 3D point of the first set of 3D points:
computing, using an inverse operation, a first set of weights based on the 3D point and the set of 3D anchor points; and
computing, using a forward operation, a 2D point mapped to the 3D point based on the first set of weights and the set of 2D anchor points; and
outputting a first image of the 2D surface mapped onto the 3D surface using the first mapping.

2. The method of claim 1, further comprising determining an embedded representation of the plurality of 3D points.

3. The method of claim 2, wherein determining the embedded representation of the plurality of 3D points comprises:
determining a subset of the plurality of 3D points;
generating a matrix including a distance between each first 3D point of the plurality of 3D points and each second 3D point of the subset of the plurality of 3D points;
computing a first embedded coordinate for each second 3D point of the subset of the plurality of 3D points using the matrix and a metric multi-dimensional scaling technique; and
computing a second embedded coordinate for each first 3D point of the plurality of 3D points using an interpolation technique.

4. The method of claim 3, wherein:
the inverse operation comprises computing a distance between the 3D point and each 3D anchor point of the set of 3D anchor points; and
each distance between the 3D point and a 3D anchor point is based on the embedded representation of the 3D point and the 3D anchor point.

5. The method of claim 1, wherein:
the 3D mesh is comprised of a plurality of 2D triangles, each 2D triangle being defined by three 3D vertices from the plurality of 3D points; and
each 3D anchor point of the set of 3D anchor points is a point inside a 2D triangle of the plurality of 2D triangles, wherein each 3D anchor point corresponds to three 3D points of the plurality of 3D points that are the three 3D vertices of the 2D triangle.

6. The method of claim 5, wherein the first set of 3D points comprises a set of 3D vertices corresponding to the plurality of 2D triangles associated with each 3D anchor point of the set of 3D anchor points.

7. The method of claim 5, wherein determining the first mapping further comprises:
determining a second set of 3D points; and
for each 3D point of the second set of 3D points:
computing, using the forward operation, a second set of weights based on the 3D point and the set of 3D anchor points; and
computing, using the inverse operation, a 2D point mapped to the 3D point based on the second set of weights and the set of 2D anchor points.

8. The method of claim 7, wherein determining the second set of 3D points comprises:
for each mapped 2D point, comparing the mapped 2D point to a predefined boundary condition; and
responsive to the mapped 2D point satisfying the predefined boundary condition, determining the second set of 3D points based on the 3D point to which the mapped 2D point was mapped using a point selection technique.

9. The method of claim 8, wherein the point selection technique comprises:
for each 3D point to which a 2D point was mapped, determining a set of neighboring 3D points using the 3D mesh;
for each 3D point of the set of neighboring 3D points:
determining whether the 3D point has previously been selected; and
responsive to determining that the 3D point has not been previously selected, add the 3D point to the second set of 3D points.

10. The method of claim 8, wherein the point selection technique comprises:
determining one or more partitions of the 3D mesh, each partition comprising one or more 3D points of the plurality of 3D points;
for each 3D point to which a 2D point was mapped, determining a set of neighboring 3D points using the 3D mesh;
for each 3D point of the set of neighboring 3D points:
determining a partition that includes the 3D point;
for each 3D point of the partition that includes the 3D point:
determining whether the 3D point has previously been selected; and
responsive to determining that the 3D point has not been previously selected, add the 3D point to the second set of 3D points.

11. The method of claim 8, wherein the predefined boundary condition is based on inclusion in a convex hull defined by the set of 2D anchor points.

12. The method of claim 7, wherein each 3D point of the first set of 3D points and each 3D point of the second set of 3D points are processed in parallel.

13. A system comprising:
one or more processors; and
one or more computer-readable storage media storing instructions which, when executed by the one or more processors, cause the one or more processors to perform operations including:
receiving first information about a 3D surface characterized by a 3D mesh, the 3D mesh comprising a plurality of 3D points;
receiving second information about a 2D surface, the 2D surface comprising a plurality of 2D points;
receiving a first selection of a set of 2D anchor points from among the plurality of 2D points;
for each 2D anchor point of the set of 2D anchor points, receiving a second selection of a 3D anchor point mapped to the 2D anchor point to generate a set of 3D anchor points;
selecting one or more first subsets of the plurality of 3D points using a selection policy;
determining a first mapping of a second subset of the 2D points to the one or more first subsets of the plurality of 3D points using the set of 2D anchor points and the set of 3D anchor points, each of the one or more first subsets of the plurality of 3D points being mapped in parallel, comprising:
for each 3D point of the one or more first subsets of the plurality of 3D points:
computing, using an inverse operation, a first set of weights based on the 3D point and the set of 3D anchor points; and
computing, using a forward operation, a 2D point mapped to the 3D point based on the first set of weights and the set of 2D anchor points; and
outputting a first image of the 2D surface mapped onto the 3D surface using the first mapping.

14. The system of claim 13, wherein the selection policy comprises:
for each 3D point to which a 2D point was mapped, determining a set of neighboring 3D points using the 3D mesh;
for each 3D point of the set of neighboring 3D points:
determining whether the 3D point has previously been selected; and
responsive to determining that the 3D point has not been previously selected, add the 3D point to one or more second subsets of the plurality of 3D points.

15. The system of claim 13, wherein the selection policy comprises:
determining one or more partitions of the 3D mesh, each partition comprising one or more 3D points of the plurality of 3D points;
for each 3D point to which a 2D point was mapped, determining a set of neighboring 3D points using the 3D mesh;
for each 3D point of the set of neighboring 3D points:
determining a partition that includes the 3D point;
for each 3D point of the partition that includes the 3D point:
determining whether the 3D point has previously been selected; and
responsive to determining that the 3D point has not been previously selected, add the 3D point to one or more second subsets of the plurality of 3D points.

16. The system of claim 13, wherein determining the first mapping further comprises:
selecting one or more third subsets of the plurality of 3D points using the selection policy; and
for each 3D point of the one or more third subsets of the plurality of 3D points:
computing, using the forward operation, a second set of weights based on the 3D point and the set of 3D anchor points; and
computing, using the inverse operation, a 2D point mapped to the 3D point based on the second set of weights and the set of 2D anchor points.

17. A non-transitory computer-readable medium storing instructions that, when executed by one or more processors, cause the one or more processors to perform operations including:
receiving first information about a 3D surface characterized by a 3D mesh, the 3D mesh comprising a plurality of 3D points;
a step for generating an embedded representation of the plurality of 3D points;
receiving second information about a 2D surface, the 2D surface comprising a plurality of 2D points;
a step for receiving a selection of a set of anchor point pairs, each pair comprising a 2D anchor point from among the 2D point and a 3D anchor point from among the 3D points;
a step for selecting a first subset of the plurality of 3D points using a selection policy;
a step for determining a first mapping of a second subset of the 2D points to the first subset of the plurality of 3D points using the set of anchor point pairs using the embedded representation; and
outputting a first image of the 2D surface mapped onto the 3D surface using the first mapping.

18. The computer-readable medium of claim 17, wherein the selection policy comprises:
for each 3D point to which a 2D point was mapped, determining a set of neighboring 3D points using the 3D mesh;
for each 3D point of the set of neighboring 3D points:
determining whether the 3D point has previously been selected; and
responsive to determining that the 3D point has not been previously selected, add the 3D point to a second subset of 3D points.

19. The computer-readable medium of claim 17, wherein the selection policy comprises:
determining one or more partitions of the 3D mesh, each partition comprising one or more 3D points of the plurality of 3D points;
for each 3D point to which a 2D point was mapped, determining a set of neighboring 3D points using the 3D mesh;
for each 3D point of the set of neighboring 3D points:
determining a partition that includes the 3D point;
for each 3D point of the partition that includes the 3D point:
determining whether the 3D point has previously been selected; and
responsive to determining that the 3D point has not been previously selected, add the 3D point to a second subset of 3D points.

20. The computer-readable medium of claim 17, wherein:
the step for determining the first mapping comprises an inverse operation comprising computing distances between first 3D points of the first subset of the plurality of 3D points and first 3D anchor points of the 3D anchor points from the set of anchor point pairs; and
each distance is based on the embedded representation.
